(19) United States
(12) Patent Application Publication
(10) Pub. No.: US 2003/0229687 A1
(43) Pub. Date: Dec. 11, 2003

(54) Presence administration method and device

(75) Inventors: Takashi Ohno, Kawasaki (JP); Shingo Fujimoto, Kawasaki (JP); Jun Kakuta, Kawasaki (JP); Masahiko Murakami, Kawasaki (JP); Sumiyo Okada, Kawasaki (JP); Akinori Iwakawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/453,655

(22) Filed: Jun. 4, 2003

(30) Foreign Application Priority Data
Jun. 11, 2002 (JP) 2002-170295

(51) Int. Cl. G06F 15/177

(52) U.S. Cl. 709/220

(57) ABSTRACT

Restricting the setting of presence information by presentities. Among other forms of presence information, restricted presence information that a user agent cannot determine him/herself is established. If among other forms of presence information “game score” is for example made restricted presence information, only user agent B, being a game administrator, would be able to determine the “game score.” When user agent A's game score is updated by user agent B, the game score is reported to user agent A's Watcher C.

### BACKGROUND OF THE INVENTION

1. Technical Field

The present invention relates to presence systems enabling a user on a network to access presence information on other users.

Presence systems in terms of the present invention comprise servers and clients. A server stores presence information on a user agent who operates a client, and broadcasts the presence information to other clients. The possessor of broadcasted presence information is referred to as a “presentity.” The operator of a client that receives presence information from a presentity is referred to as a “watcher.” Presence information herein is arbitrary information on a presentity and may be, to name examples, text-message or icon files indicating status, or personal information such as residential and communications addresses.

2. Description of the Related Art

Communications services enabling connection to the Internet at all times from homes and offices, and mobile telephones that can connect to the Internet have spread rapidly of late. With such infrastructure in place as a background, presence systems that let a user access on a network presence information on other users are coming to be utilized in day-to-day living and in the workplace. Utilization of instant messaging systems (“IM systems” hereinafter), by which users exchange text messages amongst themselves in real time, has moreover become commonplace. Inasmuch as some presence systems handle text messages as a part of presence information, presence systems will hereinafter be taken to include IM systems.

In presence systems, a presentity possess presence information. Presentities are free to change their own presence information. Users, by registering in a server presentities (“buddies” hereinafter) in whom they are interested, then make requests to be notified of updated information. The server receiving the request broadcasts the buddy presence information to watchers, who are requesters. The canceling of a request for an updated information alert is limited to the watcher that formed the request, or else to that watcher's buddies.

Presence information is as just noted information that the presentity who owns it can alter freely. Depending on the properties of the presence information, however, that would be a problem if the presentity were to freely alter the information. In a situation for example in which a number of users are playing a game via a network, game scores could conceivably be handled as presence information. It would be preferable in this case that the players not be able to tamper with the game scores.

Likewise, a watcher's canceling a request for an updated information alert would in some instances be unsuitable. For example, there is a method of advertising over a presence system, whereby customers designate providers of products and services as buddies, and advertising information that is presence information by the providers is reported to the designators. In return for this, the product/etc. providers award the customers privileges in connection with their companies' products. In this case the advertising information is broadcast as presence information by the product/etc. providers to watchers who are the customers. A watcher canceling at will a request for an updated information report risks not being able to have him or her look at the advertising.

### BRIEF SUMMARY OF THE INVENTION

An issue for the present invention is in presence systems to restrict the determination of presence information by presentities. A separate issue for the present invention is to determine distribution relationships for presence information broadcast by third parties. A still further issue for the present invention is in presence systems to restrict cancellation of set broadcasting relationships.

The present invention in a first aspect is a presence administration method for utilization in a presence administration device that administrates presence information on a client group including a first client, the presence administration method including: a presence-storage step of storing client-by-client presence information on the client group; a broadcast-destination storage step of storing, client-by-client, identifiers for broadcasting destinations for the presence information on the client group; an information-receipt step of receiving, from the first client, notification (referred to as “first configuration alert” hereinafter) of fresh presence information on the first client; an update control step of judging whether to update the presence information on the first client when the first configuration alert has been received, and controlling updating of the presence information according to the judgment results; and a broadcast step of broadcasting the updated presence information to the first client's presence-information broadcasting destination if the presence information has been updated in the update control step.

This method restricts a user agent who operates a client on an instant messaging system against configuring his/her own presence information. For example, restricted presence information the possessor of which can neither register nor update is provided among presence information. If the user agent has transmitted to the server a configuration alert in order to register or else update restricted presence information, the server will not update the restricted presence information.

In a second aspect, the present invention is the presence administration method just set forth, with the presence information including regular presence information, being configurable by presence-information possessors, and restricted presence information, being nonconfigurable by presence-information possessors; wherein the update control step includes: a substep of judging whether the fresh presence information received in the first configuration alert is regular presence information or restricted presence information; a substep, if the fresh presence information is regular presence information, of updating the regular presence information on the first client; and a substep, if the fresh presence information is restricted presence information, of not updating the restricted presence information on the first client.

Conceivable for example is a situation in which “game scores” from a game that companion user agents play over a network and “remarks” from the user agents are included in presence information. Inasmuch as user agents themselves being able to alter “game scores” would be unsuitable, these would be configured as restricted presence information. “Remarks” would be configured as regular presence information, and registration and updating by user agents themselves would be possible.

The invention in a third aspect is the presence administration method set forth in the first aspect, wherein the information-receipt step further receives, from a second client included in the client group, notification (second configuration alert) of fresh presence information on the first client; and the update control step updates, based on the second configuration alert, the presence information on the first client.

A certain user agent B may register and update all or a portion of the presence information on another user agent A. More specifically, the server receives a configuration alert for presence information on user agent A from user agent B's client. The presence information on user agent A is updated based on the configuration alert from user agent B.

A fourth aspect of the invention is the presence administration method set forth in the third aspect, the presence information including restricted presence information, being nonconfigurable by presence-information possessors, and identifiers for enabled configurants permitted to configure the restricted presence information; wherein the update control step includes: a substep of judging whether or not the fresh presence information received in the second configuration alert is restricted presence information; a substep, if the fresh presence information is restricted presence information, of judging whether or not the second client is an enabled configurant; and a substep, if the second client is an enabled configurant, of updating based on the first configuration alert the restricted presence information on the first client.

For example, presence information on user agent A contains the restricted presence information “game score,” the regular presence information “remarks,” and “enabled configurant ID.” User agent B being able to make a setting on user agent A's game score would be an instance in which user agent B is included in user agent A's enabled configurants.

In a fifth aspect, the presence administration method is as set forth in the third aspect, but with the presence information including a plurality of restricted presence information candidates, being nonconfigurable by presence-information possessors; further including: a selection step of accepting from the first client among the restricted presence information candidates selection of which candidate is to be made current restricted presence information; wherein the update control step judges whether or not the restricted presence information received through the second configuration alert is the current restricted presence information, and based on the judgment results updates the current restricted presence information for the first client.

Were the restricted presence information a store advertisement for example, only user agent B could update the store ad, inasmuch as it itself would be the restricted presence information. User agent A nevertheless could choose, as his/her own presence information, the store whose advertising is used. If for example restricted presence information candidates were “Store SP1,” “Store SP2,” and “Store SP3,” user agent A would choose “Store SP1” as current restricted presence information when user agent A wants to set its as his/her own presence information.

A sixth aspect of the invention is the presence administration method as set forth in the fifth aspect, and further including a candidate-selection step of accepting selection of the restricted presence-information candidate.

If for example user agent A wanted to add “Store SP4” to the restricted presence-information candidates, that choice would be accepted.

The present invention in a seventh aspect is a presence administration device for administrating presence information on a client group including a first client, the presence administration device comprising: presence-storage means for storing client-by-client presence information on the client group; broadcast-destination storage means for storing, client-by-client, identifiers for broadcasting destinations for the presence information on the client group; information-receipt means for receiving, from the first client, notification (referred to as “first configuration alert” hereinafter) of fresh presence information on the first client; update control means for judging whether to update the presence information on the first client when the first configuration alert has been received, and controlling updating of the presence information according to the judgment results; and broadcast means for broadcasting the updated presence information to the first client's presence-information broadcasting destination if the presence information has been updated in the update control step.

This aspect of the invention demonstrates actions and effects similar to those of the foregoing first aspect.

The invention in an eighth aspect is a presence administration computer product utilized in a computer that administrates presence information on a client group including a first client, the presence administration computer product for causing the computer to function as: presence-storage means for storing client-by-client presence information on the client group; broadcast-destination storage means for storing, client-by-client, identifiers for broadcasting destinations for the presence information on the client group; information-receipt means for receiving, from the first client, notification (referred to as “first configuration alert” hereinafter) of fresh presence information on the first client; update control means for judging whether to update the presence information on the first client when the first configuration alert has been received, and controlling updating of the presence information according to the judgment results; and broadcast means for broadcasting the updated presence information to the first client's presence-information broadcasting destination if the presence information has been updated in the update control step.

This aspect of the invention demonstrates actions and effects similar to those of the foregoing first aspect.

In a ninth aspect the present invention provides a computer-readable recording medium on which is recorded a presence administration program utilized in a presence administration device for administrating presence information on a client group including a first client. The computer-readable recording medium on which is recorded the presence administration program is for executing the following steps:

a presence-storage step of storing client-by-client presence information on the client group;

a broadcast-destination storage step of storing, client-by-client, identifiers for broadcasting destinations for the presence information on the client group;

an information-receipt step of receiving, from the first client, notification (referred to as “first configuration alert” hereinafter) of fresh presence information on the first client;

an update control step of judging whether to update the presence information on the first client when the first configuration alert has been received, and controlling updating of the presence information according to the judgment results; and

a broadcast step of broadcasting the updated presence information to the first client's presence-information broadcasting destination if the presence information has been updated in the update control step.

This aspect of the invention demonstrates actions and effects similar to those of the foregoing first aspect. Recording media herein may be, to name examples, flexible disks, hard disks, semiconductor memory, CD-ROMs, DVDs, magneto-optical disks (MOs), and other computer-read/writeable recording media.

In a tenth aspect the present invention is a presence configuration method including: a connection step of connecting to a presence administration device for administrating presence information on a client group, the presence administration device being a first client included in the client group; and a configuration control step of restricting configuration of the presence information on the first client, and transmitting to the presence administration device presence information for which configurational settings have been accepted.

This method is utilized in a situation that restricts the client-end registering and updating of presence information on a user agent him/herself. A client to which this method is applied would not accept, through a screen on which settings for presence information on user agent A for example are made, registration of or updates for the restricted presence information just noted.

The present invention in an eleventh aspect is a presence configuration method including: a connection step of connecting to a presence administration device for administrating presence information on a client group including a first client and a second client, the presence administration device being the second client; and a transmission step of transmitting to the presence administration device a presence-information report containing fresh presence information on the first client.

This method is utilized in a situation that registers or updates, with user agent B's client, restricted presence information on other user agent A. User agent B's client, to which this method is applied, displays the restricted presence information on other user agent A and accepts onscreen updating thereof, for example.

A twelfth aspect of the present invention provides a presence administration method for utilization in a presence administration device that administrates presence information on a client group including a first client, a second client and a third client. The presence administration method includes the following steps.

a presence-storage step of storing client-by-client presence information on the client group;

a broadcast-configuration step of accepting from the third client a broadcasting setting designating the second client to be a broadcast destination for the presence information on the first client;

a broadcast-configuration storage step of storing the broadcasting setting;

an information reception step of receiving notification of fresh presence information on the first client;

a broadcast step of broadcasting to the second client the presence information on the first client, based on the broadcasting setting.

To illustrate: user agents A, B and C might operate clients A, B and C. The server might accept from client B a setting (“broadcasting setting” hereinafter) according to which presence information on user agent A is transmitted to client C. User agent A would be stored as user agent C's presentity. User agent C would be stored as user agent A's watcher.

A thirteenth aspect of the invention is the presence administration method as defined above, further including: a cancellation-reception step of receiving an instruction for cancellation of the broadcasting setting; and a first cancellation control step of judging whether the instruction for cancellation of the broadcasting setting has been transmitted from the second client, having been established as a broadcast destination for the presence information, and restricting cancellation of the broadcasting setting based on the judgment results.

Were likewise as just mentioned a broadcasting setting for the transmission by user agent B of presence information on user agent A to client C executed, then if cancellation of the broadcasting setting were instructed from, e.g., user agent C who is a watcher, the server would not accept the instruction.

A fourteenth aspect is the presence administration method as defined in the thirteenth aspect, wherein: the broadcast-configuration step further accepts setting of a broadcaster flag indicating whether the second client, established as a broadcast destination for the presence information, can cancel the broadcasting setting; the broadcast-configuration storage step further stores the broadcaster flag; and the first cancellation control step restricts cancellation of the broadcasting setting, based on the broadcaster flag.

Were likewise as just mentioned a broadcasting setting for the transmission by user agent B of presence information on user agent A to client C executed, then the broadcasting setting would include an instruction as to whether someone could cancel the broadcasting setting. The server would store the instruction correlatively with the broadcasting setting, and if it has received an instruction to cancel the broadcasting setting, the server would carry the process out depending on whether or not the requester has canceling authority.

In a fifteenth aspect, the presence administration method is as set forth in the twelfth aspect, further including: a cancellation-reception step of receiving an instruction for cancellation of the broadcasting setting configured by the third client; and a second cancellation control step of judging whether the instruction for cancellation of the broadcasting setting has been transmitted from the first client, being a presence-information provider, and restricting cancellation of the broadcasting setting based on the judgment results.

Were likewise as just mentioned a broadcasting setting for the transmission by user agent B of presence information on user agent A to client C executed, then if cancellation of the broadcasting setting has been instructed through user agent A, being for example a presentity, the server need not accept the instruction.

The presence administration method in a sixteenth aspect of the present invention is as set forth in as defined in the fifteenth aspect, further wherein: the broadcast-configuration step further accepts setting of a provider flag indicating whether the first client, designated as a presence-information provider, can cancel the broadcasting setting; the broadcast-configuration storage step further stores the provider flag; and the second cancellation control step restricts cancellation of the broadcasting setting, based on the provider flag.

Were likewise as just mentioned a broadcasting setting for the transmission by user agent B of presence information on user agent A to client C executed, then the broadcasting setting would include an instruction as to whether someone could cancel the broadcasting setting. The server would store the instruction correlatively with the broadcasting setting, and if it has received an instruction to cancel a broadcasting setting would carry the process out depending on whether or not the requester has canceling authority.

The invention in an seventeenth aspect is a presence administration device for administrating presence information on a client group including a first client, a second client and a third client, the presence administration device comprising: presence-storage means for storing client-by-client presence information on the client group; broadcast-configuration means for accepting from the third client a broadcasting setting designating the second client to be a broadcast destination for the presence information on the first client; broadcast-configuration storage means for storing the broadcasting setting; information reception means for receiving notification of fresh presence information on the first client; broadcast means for broadcasting to the second client the presence information on the first client, based on the broadcasting setting.

This aspect of the invention demonstrates actions and effects similar to those of the foregoing twelfth aspect.

The invention in an eighteenth aspect is a presence administration computer product for running on a computer that administrates presence information on a client group including a first client, a second client and a third client, the presence administration computer product for causing the computer to function as: presence-storage means for storing client-by-client presence information on the client group; broadcast-configuration means for accepting from the third client a broadcasting setting designating the second client to be a broadcast destination for the presence information on the first client; broadcast-configuration storage means for storing the broadcasting setting; information reception means for receiving notification of fresh presence information on the first client; broadcast means for broadcasting to the second client the presence information on the first client, based on the broadcasting setting.

This aspect of the invention demonstrates actions and effects similar to those of the foregoing twelfth aspect.

In a nineteenth aspect, the present invention is a computer-readable recording medium on which is recorded a presence administration program utilized for administrating presence information on a client group including a first client, a second client and a third client. The computer-readable recording medium on which is recorded the presence administration program is for executing the following steps.

a presence-storage step of storing client-by-client presence information on the client group;

a broadcast-configuration step of accepting from the third client a broadcasting setting designating the second client to be a broadcast destination for the presence information on the first client;

a broadcast-configuration storage step of storing the broadcasting setting;

an information reception step of receiving notification of fresh presence information on the first client;

a broadcast step of broadcasting to the second client the presence information on the first client, based on the broadcasting setting.

This aspect of the invention demonstrates actions and effects similar to those of the foregoing twelfth aspect. Recording media herein conceivably would be similar to those described earlier.

A twentieth aspect of the invention is a presence broadcast-configuration method including:

a connection step of connecting to a presence administration device as a third client, wherein the presence administration device administrates presence information on, and broadcasting it to, a client group including a first client, a second client, and a third client; and

a transmission step of transmitting to the presence administration device a broadcasting setting designating the second client to be a broadcast destination for the presence information on the first client.

This method may be utilized in a situation in which user agent B's client configures broadcasting settings on user agents A and C. This method having been applied to user agent B's client, it would accept broadcasting settings to the effect that presence information on, for example, other user agent A is transmitted to user agent C's client.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is an overall configurational diagram of a presence system having to do with a first embodiment example;

FIG. 2 is a functional configuration of and information flow through a presence administration unit (user agent B);

FIG. 3 is a functional configuration of and information flow through a presence administration unit (user agent A);

FIG. 4 is a conceptual explanatory diagram of a presence table (user agent A);

FIG. 5 is an example of presence settings menus;

FIG. 6 is (a) an example of a presence display menu (user agent E), and (b) an example of a presence configuration menu (user agent E);

FIG. 7 is a flowchart representing exemplary flow of a process that a server carries out (a first embodiment example);

FIG. 8 is an overall configurational diagram of a presence system having to do with a second embodiment example;

FIG. 9 is a functional configuration of and information flow through a presence administration unit (user agent A);

FIG. 10 is (a) a presence table (user agent A), and (b) an options table;

FIG. 11 is (a) an example of a menu for selecting current restricted information, and (b) an example of a menu for selecting restricted-presence-information candidates;

FIG. 12 is a flowchart representing exemplary flow of a process that a server carries out (a second embodiment example);

FIG. 13 is an overall configurational diagram of a presence system having to do with a third embodiment example;

FIG. 14 is a functional configuration of and information flow through the presence administration units in FIG. 13 (user agent B);

FIG. 15 is a functional configuration of and information flow through the presence administration units in FIG. 13 (user agent A);

FIG. 16 is a functional configuration of and information flow through the presence administration units in FIG. 13 (user agent C);

FIG. 17 is a conceptual explanatory diagram of a watcher table (user agent A);

FIG. 18 is a conceptual explanatory diagram of a buddy list (user agent C);

FIG. 19 is examples of broadcasting-settings menus that a client displays, wherein (a) is an example of a menu for establishing a presentity in advance, and (b) is an example of a menu for establishing a watcher in advance;

FIG. 20 is a flowchart representing exemplary flow of a process that a server carries out (a third embodiment example); and

FIG. 21 is an embodying example in which the presence system of the third embodiment example has been applied in a preapproval system.

### DETAILED DESCRIPTION OF THE INVENTION

### First Embodiment Example

(1) Overall Outline

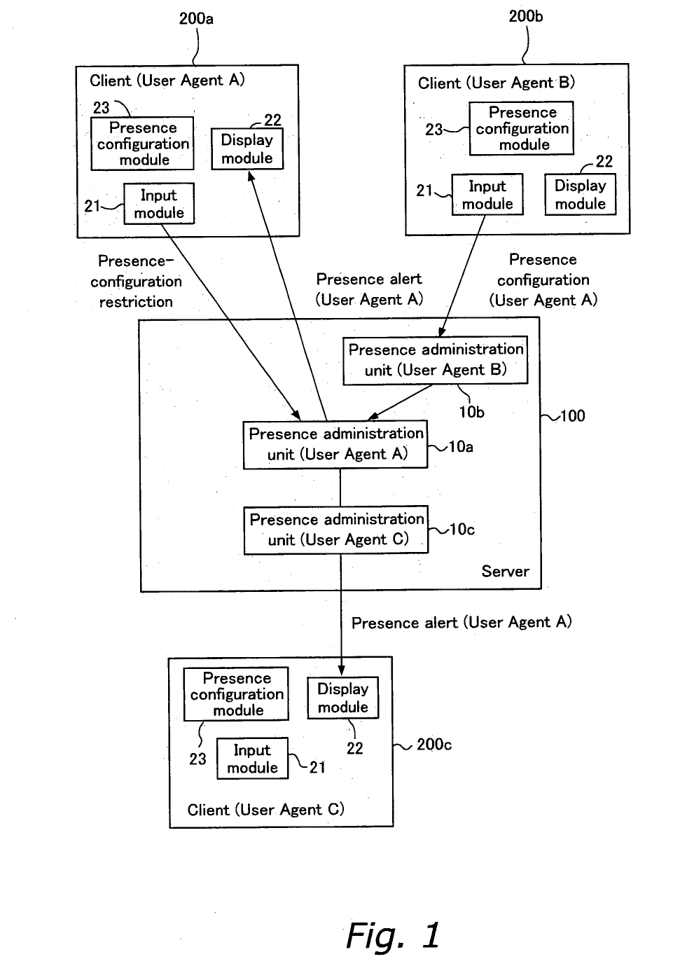

FIG. 1 sets forth a conceptual explanatory diagram of a presence system having to do with a first embodiment example of the present invention. In this presence system user agents are restricted in determining their own presence information. In some instances moreover, user agents may determine others' presence information.

The presence system is configured to include a server 100 and a plurality of clients 200a, 200b, 200c, . . . . User agents A, B, C, . . . operate the respective clients 200a, 200b, 200c, . . . . The server 100 has presence administration units 10a, 10b, 10c, . . . that correspond to the clients 200. The presence administration units 10 chiefly perform the following processes.

(s1) Presence-information administration by a corresponding user agent.

(s2) Administration of presence-information broadcasting relationships.

(s3) Reporting of presence information to watchers' presence administration units (internal change notification).

(s4) Reporting latest presence information on buddies to clients (presence notification). It should be understood that in a situation in which a certain user agent B wants to access presence information on a user agent A, user agent A is referred to as user agent B's buddy.

(s5) Restricting determination of presence information.

Meanwhile, the clients 200 chiefly perform the following processes.

(c1) Configuring on the server 100 presence information on a corresponding user agent.

(c2) Configuring on the server 100 presence information on another user agent apart from the corresponding user agent.

(c3) Configuring buddies on the server 100.

(c4) Acquiring and displaying presence information on buddies.

(2) Server

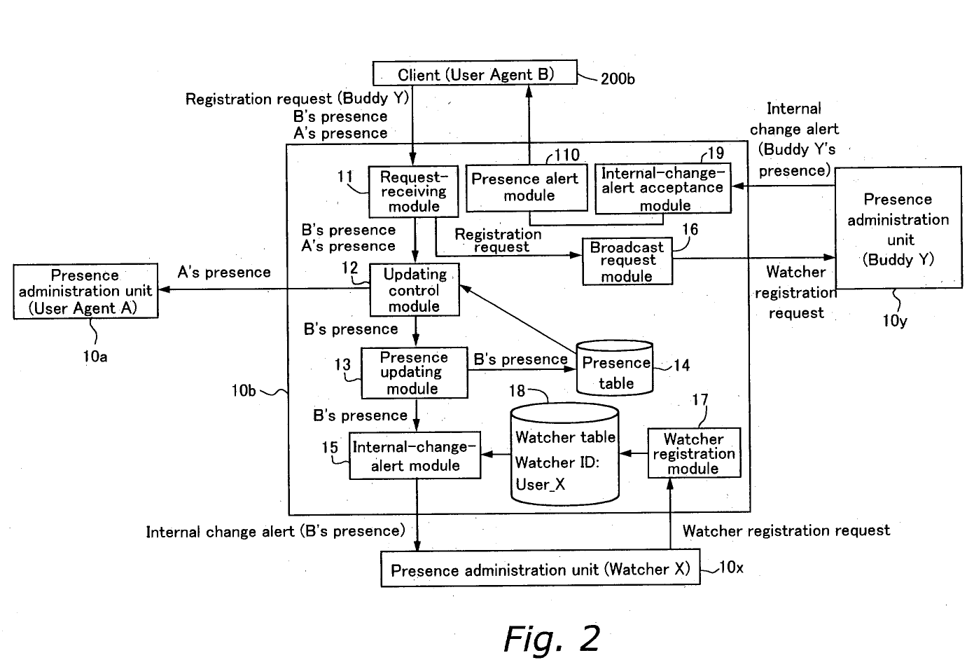

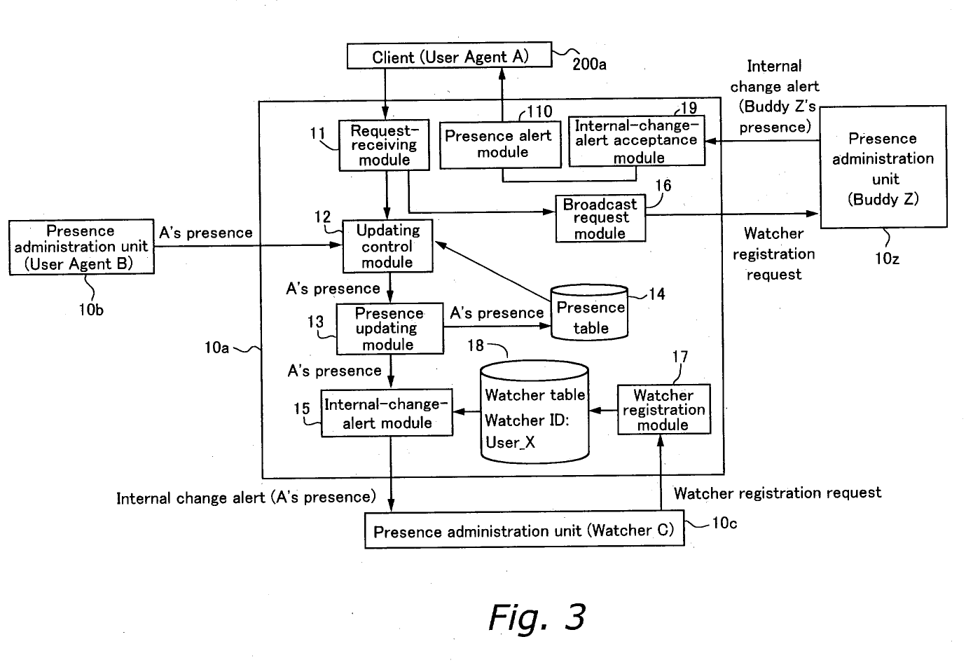

FIGS. 2 and 3 are explanatory diagrams illustrating the detailed configuration of the presence administration units 10 that the server 100 includes. Presence administration unit 10b for user agent B and presence administration unit 10a for user agent A are illustrated in FIGS. 2 and 3, but the functional configuration of the other presence administration units 10 is the same. Likewise, presence administration unit 10b has the functions of presence administration unit 10a, and vice-versa. Below, with reference to FIGS. 2 and 3 the functions of the presence administration units 10 will be explained in correlation with abovementioned Functions (s1) through (s5).

(s1, s3, s4) Presence-Information Administration, Internal Change Notification and Presence Notification

Referring to FIG. 2: The latest presence information on user agent B from client 200b is received by a request-receiving module 11, and the latest presence information is written into a presence table 14 by a presence updating module 13 (Function s1). The latest presence information on user agent B is moreover reported to presence administration unit 10x for user agent B's Watcher X through the internal change notification of an internal-change-notification module 15 (Function s3). This presence information is transmitted to client 200x from a presence notification module 110 for the presence administration unit 10x (presence notification, Function s4). The presence notification is transmitted by the presence notification module 110.

(s2) Administration of Presence-Information Broadcasting Relationships

Meanwhile, when a Buddy Y registration request is transmitted from user agent B's client 200b to the request-receiving module 11, a watcher registration request is transmitted by a broadcast request module 16 to the presence administration unit 10y for Buddy Y (FIG. 2 reference). This request is written into a watcher table 18 by a watcher registration module 17 for the presence administration unit 10y. user agent B is thereby stored as a watcher in presence administration unit 10y for designated Buddy Y.

(s5) Restricting Determination of Presence Information

In an imaginable situation, for example, in which “game scores” from a game played by companion user agents over a network and “remarks” from the user agents are included in presence information, with the possessors themselves being able to determine them, the “game scores” would be unsuitable in that there would be a likelihood of tampering. Given that situation, user agents apart from the possessors of the game scores determining the presence information would restrict the determination of presence information through the possessors.

The presence administration unit 10b might for example sometimes receive from client 200b a presence-information configuration alert for a user agent apart from user agent B, e.g., user agent A. The presence information contained in this configuration alert would be received by the request-receiving module 11 and sent by an updating control module 12 to user agent A's presence administration unit 10a (FIG. 2 reference). Conversely, presence administration unit 10b at times may not perform the configuration it receives in a presence-information configuration alert for user agent B.

The functioning of presence administration units 10 of this sort will be explained taking as an example the determination of what user agent A's presence information will be—“game score”—by user agent B. User agent A's presence information, “game score,” is reported from user agent B's client 200b to presence administration unit 10b, and by the updating control module 12 is sent to presence administration unit 10a and stored (FIGS. 2, 3 reference). Subsequently, user agent A's fresh game scores are reported to watcher(s), for example presence administration unit 10c for user agent C (FIG. 3 reference).

Together with the game scores, enabled configurants and restriction flags may be sent to the presence administration unit 10a. User agent A's game scores, enabled configurants and restriction flags are received by the updating control module 12 for presence administration unit 10a and written into the presence table 14 (FIG. 3 reference). An “enabled configurant” herein is someone who can determine what presence information will be—in this case game scores. The enabled configurant in this example is user agent B. Restriction flags indicate that presence information is either restricted presence information or regular presence information. Restricted presence information is presence information whose possessor cannot register/update. Regular presence information is presence information whose possessor can register/update. It will be appreciated that the enabled configurants and restriction flags may be determined on the client end. Likewise, the settings just noted may be made on both the client and the server ends.

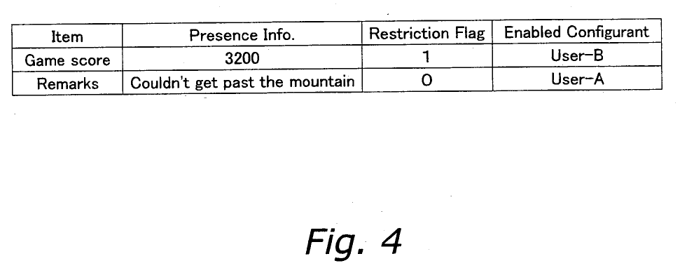

FIG. 4 is a conceptual explanatory diagram of information stored in the presence table 14. A presence table for user agent A is herein illustrated as an example. In this instance, “Item,” indicating the content of presence information, “Presence Information,” “Restriction Flag,” and “Enabled Configurant” are stored in a single record. The restriction flag if “1” indicates that presence information is restricted, and if “0” indicates that presence information is regular. Namely, “game score” presence information would be configured as restricted presence information, and “remarks” as regular presence information. User agent A him/herself is the enabled configurant of regular presence information; user agent B is herein established as the enabled configurant of restricted presence information. Consequently, though user agent A settles on “game score,” the updating control module 12 in presence administration unit 10a will not perform game-score updating. This is because user agent A is not an enabled configurant of the restricted presence information “game score.”

(3) Clients

Returning once again to FIG. 1, explanation concerning functioning of the clients 200 will be made in correlation with the above-noted functions c1 through c4. For ease of explanation, client 200b that user agent B operates will be described, but the other clients have the same functions.

(c1) Receipt, and transfer to the server 100, of presence-information settings for a corresponding user agent.

Presence information on user agent B is transmitted to the server 100 by an input module 21. The configuring of restricted presence information within the presence information may be restricted by the input module 21.

(c2) Receipt, and transfer to the server 100, of presence-information settings for another user agent apart from the corresponding user agent.

Presence information on another user agent apart from user agent B is transmitted to the server 100 by a presence configuration module 23.

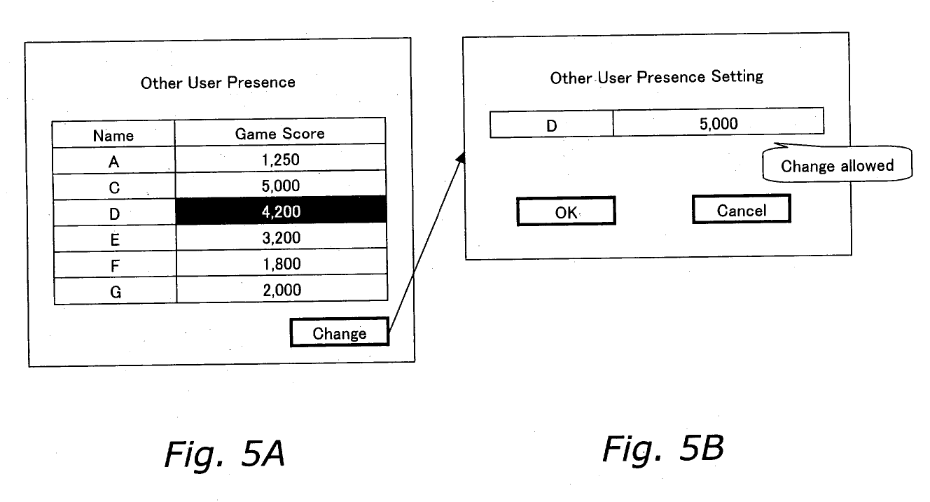

FIG. 5 is an example of a presence settings menu that the presence configuration module 23 displays. This menu accepts restricted presence-information settings by user agents apart from user agent B. This menu displays for example “Name,” being a user identifier, and restricted presence information “Game Score.” This menu furthermore accepts the selection of any user agent ((a) in the figure), and the setting of that user agent's game-score ((b) in the figure), and transmits the configured presence information to the server 100.

(c3) Buddy Registration into Server 100

User agent B's buddies are transmitted by the input module 21 to the server 100.

(c4) Acquiring and Displaying Presence Information on Buddies

Presence information on user agent B's buddies is acquired by a display module 22 from the server 100 and displayed.

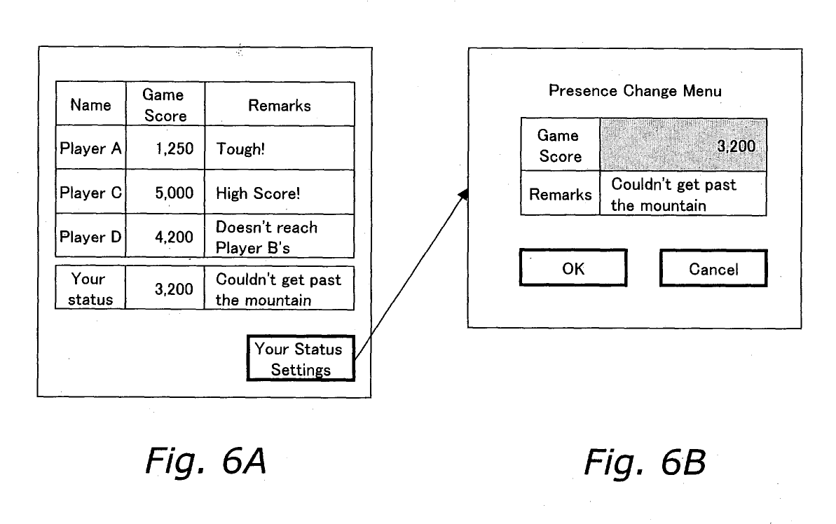

FIG. 6 sets forth single examples of a presence display menu ((a) in the figure) that the display module 22 displays, and of a presence configuration menu that the input module 21 displays ((b) in the figure). For ease of explanation menu examples that are displayed on a user agent E's client 200e are illustrated herein. The presence display menu shows presence information on user agent E's Buddies A, C and D, and presence information on user agent E. The presence configuration menu, (b) in the figure, is displayed when user agent E instructs the setting of his/her own presence information. The presence configuration menu will not accept a setting for the restricted presence information “Game Score.” On the other hand, the presence configuration menu will accept a setting for the regular presence information “Remarks.”

(4) Process

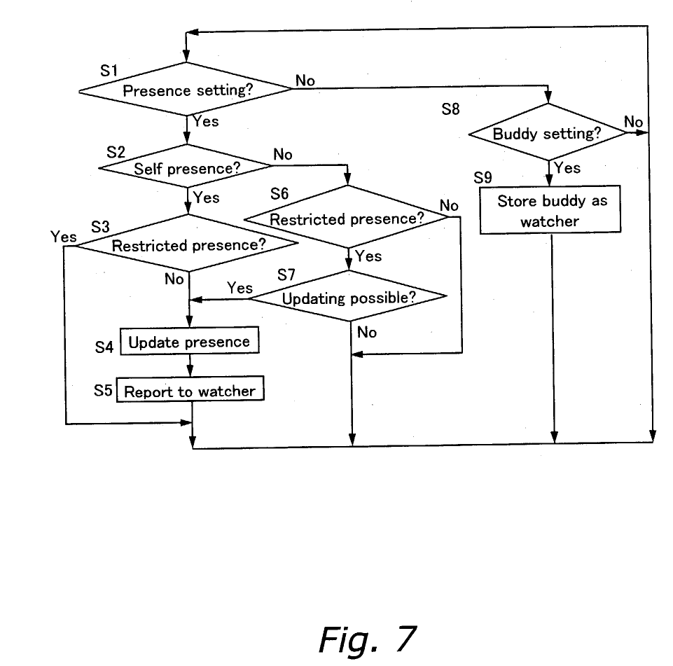

FIG. 7 is a flowchart representing an example of the flow of a process that the server 100 carries out.

Step S1: The server 100 judges whether or not a presence-information configuration request has been received from any of the clients 200. If the judgment is “Yes,” Step S2 ensues; if the judgment is “No,” later-described Step S8 ensues.

Step S2: The server 100 judges whether or not the received presence information is the configurant's own presence information. If the judgment is “Yes,” Step S3 ensues; if the judgment is “No,” later-described Step S6 ensues.

Step S3: The server 100 judges whether or not the configured presence information is restricted presence information. Inasmuch as restricted presence information may not be configured by the possessor him/herself, if the presence information is restricted, the process flow returns to Step S1. Step S4 ensues if the presence information is regular.

Steps S4, S5: The server 100 updates the presence information (S4), and reports the fresh presence information to the client for the watcher of that presence information (S5).

Steps S6, S7: If the configurant and the possessor of the presence information do not coincide, Step S6 ensues. The server 100 judges whether or not the received presence information is restricted presence information (S6). If the presence information is restricted, the server 100 judges whether or not the configurant of the presence information is an enabled configurant (S7). If the configurant of the presence information is an enabled configurant, the server 100 carries out the configuring of the presence information (S4), and reports the presence information to the watcher(s) of that presence information (S5).

Steps S8, S9: If the server 100 has received a buddy-registration request from any client 200 (S8), then the server 100 stores the requester as a watcher of the client that is designated by the buddy (S9).

User agents in the present presence system can configure presence information on other user agents. User agents, furthermore, can be restricted in the configuring of their own presence information.

### Second Embodiment Example

(1) Overall Outline

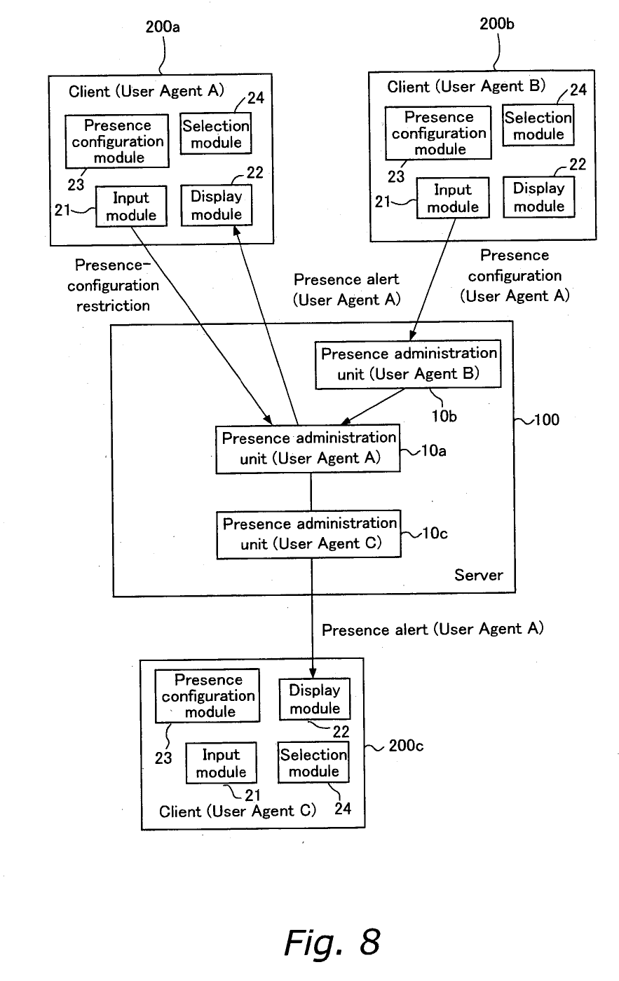

It is preferable to make it so that in a presence system in the foregoing first embodiment, clients can select items of restricted presence information. FIG. 8 is an overall configurational view of a presence system having to do with a second embodiment example. This presence system includes a server 100 and a plurality of clients 200a, 200b, 200c, . . . clients 200a, 200b, 200c, . . . are operated by user agents A, B, C, . . . . The server 100 has presence administration units 10a, 10b, 10c, . . . that correspond to clients 200a, 200b, 200c, . . . .

(2) Server

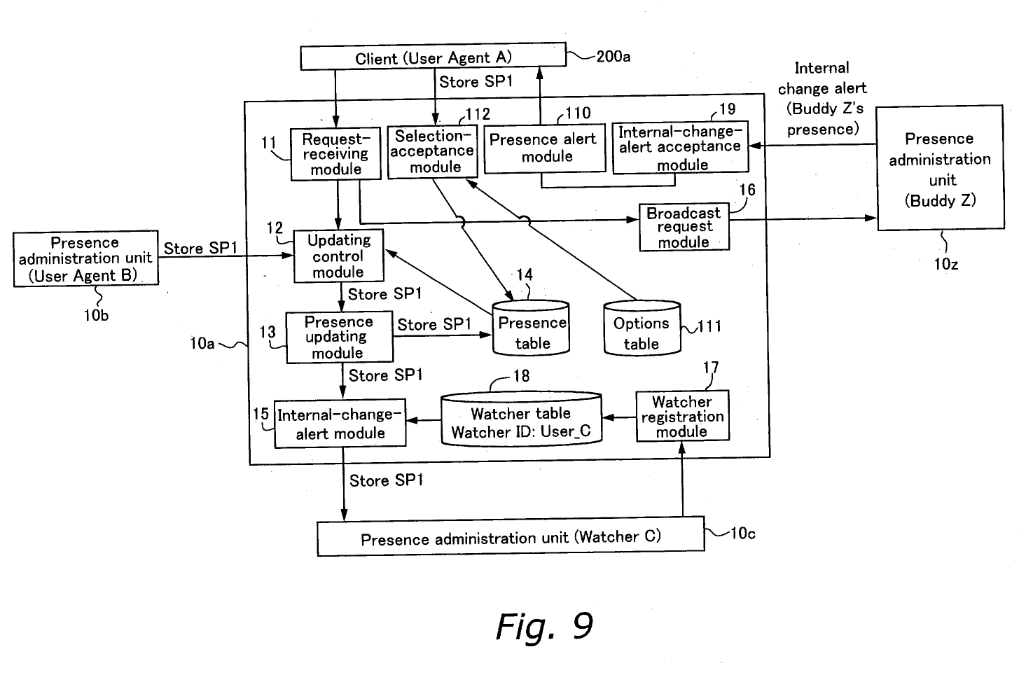

FIG. 9 is a functional configuration view of presence administration units 10 in the server 100. Although the configuration of presence administration unit 10a for user agent A is illustrated herein, the other presence administration units 10 have the same functions. presence administration unit 10a further has, in addition to the configuration of the presence administration unit in the first embodiment example, an options table 111 and a selection-acceptance module 112. Configurational elements indicated in the figure with reference marks that are the same as those in FIG. 2 function likewise as described earlier.

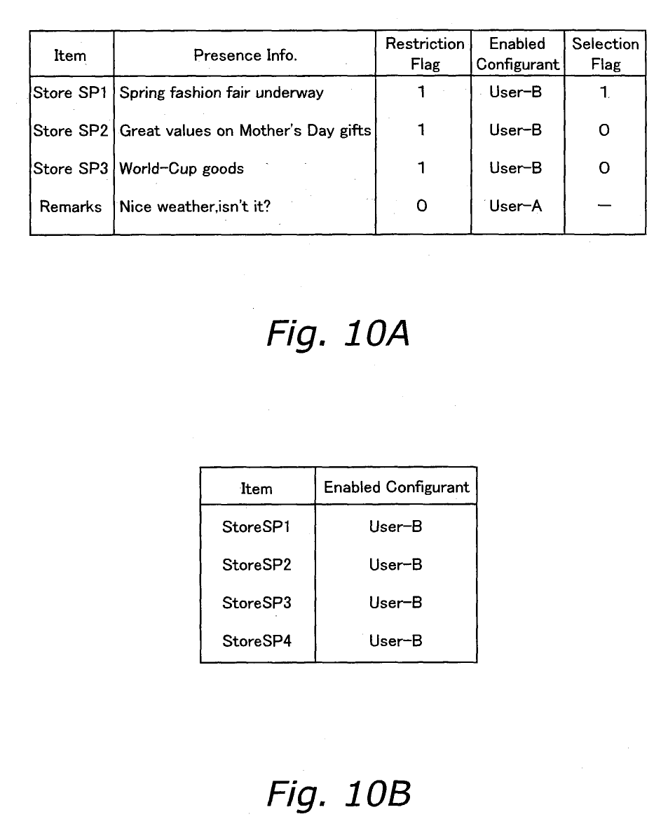

At first, with reference to FIG. 10, the options table 111 will be explained, but prior to that, the presence table 14 will be explained. FIG. 10 (a) is a conceptual explanatory diagram of information stored in the presence table 14. In this instance, “Item,” “Presence Information,” “Restriction Flag,” “Enabled Configurant,” and “Selection Flag” are stored in a single record in the presence table 14. If the selection flag is “1,” it indicates that the relevant restricted presence information has been selected as that current restricted presence information which at present is the possessor's restricted presence information. Herein, among the three restricted presence-information candidates “Store SP1,” “Store SP2” and “Store SP3,” “Store SP1” has been selected as user agent A's current restricted information.

FIG. 10(b) is a conceptual explanatory diagram of the options table 111. Items that a user agent can select as restricted presence-information candidates are stored in the options table 111. The item selected from among these is added to the user agent's presence table 14.

Functioning of the selection-acceptance module 112 will be explained using FIG. 10. The selection-acceptance module 112 at first accepts an instruction to add a restricted presence-information candidate from the options table 111 to the presence table 14. In the just-noted FIG. 10(a), the three items “Store SP1,” “Store SP2” and “Store SP3” have been selected as restricted presence-information candidates. The selection-acceptance module 112 further accepts an instruction to set at least one from among the restricted presence-information candidates as the current restricted information. In the just-noted FIG. 10(a), from among the restricted presence-information candidates “Store SP1” has been selected for the current restricted information.

(3) Client

Functioning of the clients 200 will be explained with reference once more to FIG. 8. In the figure, configurational elements labeled with reference marks that are the same as those in FIG. 1 function likewise as described earlier. The clients 200 further have, in addition to the configurational elements in the foregoing first embodiment example, selection modules 24. The selection modules 24 accept selection of current restricted information, and selection of restricted presence-information candidates.

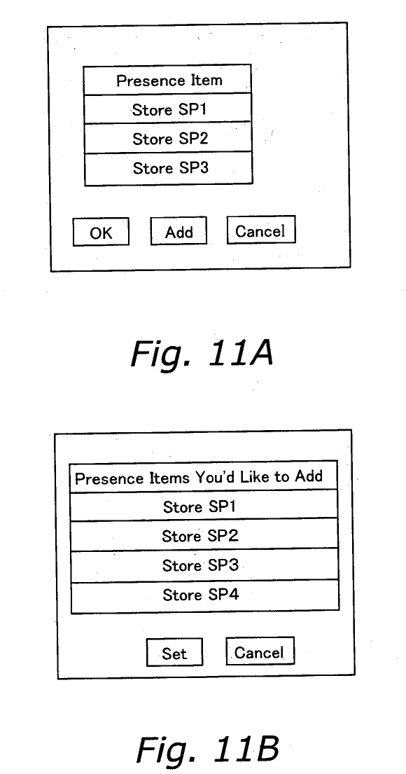

FIG. 11(a) is an example of a menu that the selection modules 24 display for selecting current restricted information. Restricted presence-information candidates are displayed in the menu. A user agent selects at least one among them, and when he/she presses for example an “OK” button, the selected restricted presence information becomes the current restricted information for that user agent. When for example an “Add” button in the menu in pressed, a menu with a selection of restricted presence-information candidates, which is exemplified in (b) in the figure, is displayed. The restricted-presence-information items that are stored in the options table 111 are displayed in this menu. When the user agent selects one or a plurality of the items and presses for example a “Set” button, the selected item(s) is stored as candidate restricted presence information in the presence table 14 for that user agent.

(4) Process

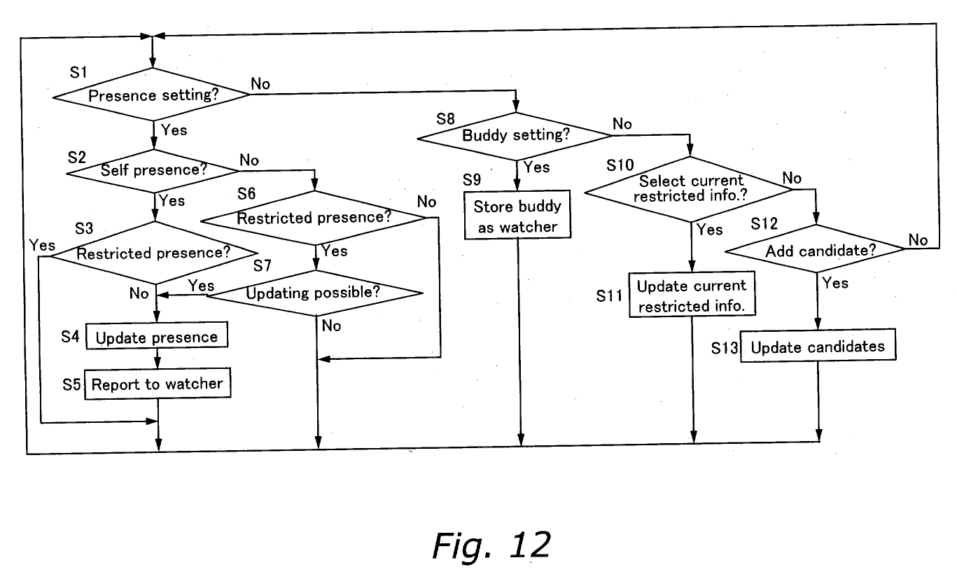

FIG. 12 is a flowchart representing an example of the flow of a process in the presence system of the present embodiment example. The routines of Step S1 through S9 are likewise as with the flow in the foregoing first embodiment example.

Step S1: If the server 100 receives a request from any of the clients 200 to make presence information settings, Step S2 ensues. When it receives a request to make buddy settings, later-described Step S8 ensues.

Step S2: If the presence information that the server 100 has received is the configurant's own presence information, Step S3 ensues, and if not, Step S6 ensues.

Step S3: If the configured presence information is restricted presence information, the server 100 returns to Step S 1. If the presence information is regular, it moves to Step S4.

Steps S4, S5: The server 100 updates the presence information (S4), and reports the fresh presence information to the watcher (S5).

Steps S6, S7: If the received presence information is restricted presence information (S6), the server 100 judges whether or not the presence information is configurable (S7). The server 100 proceeds to configure the presence information if it is configurable (S4), and reports the presence information to the watcher of that presence information (S5).

Steps S8, S9: If the server 100 has received a request from any client 200 to register a buddy(ies) (S8), then the server 100 stores the requester as a watcher of the client(s) that is designated by the buddy(ies) (S9).

Step S10: The server 100 judges whether or not a selection for current restricted presence information has been received from any of the clients 200. If the judgment is “Yes,” Step S11 ensues. If the judgment is “No,” later-described Step S12 ensues.

Step S11: The server 100 updates the just-noted current restricted presence information from the client.

Step S12: The server 100 judges whether or not the addition of a restricted presence information candidate has been instructed through any of the clients 200. If the judgment is “Yes,” Step S13 ensues; if the judgment is “No,” the process flow returns to Step S1.

Step S13: The server 100 adds the designated item to the restricted-presence-information candidates for the requesting client 200.

Thus rendering the present embodiment provides for user agents being able to select items of restricted presence information that they themselves may not configure. In an imaginable situation, for example, in which a user agent, signing up for shopping cards at one store after another, receives discount privileges from the stores, the stores in return would get to broadcast to other user agents the stores' presence information as the user agents' presence information In this case the user agent would not be able to configure the content itself of store's presence information but would nevertheless be able to select which store's presence information is broadcast as his/her own presence information. Moreover, the stores where the user agent has newly signed up for a shopping card could be made his/her own restricted presence-information candidates.

### Third Embodiment Example

(1) Overall Outline

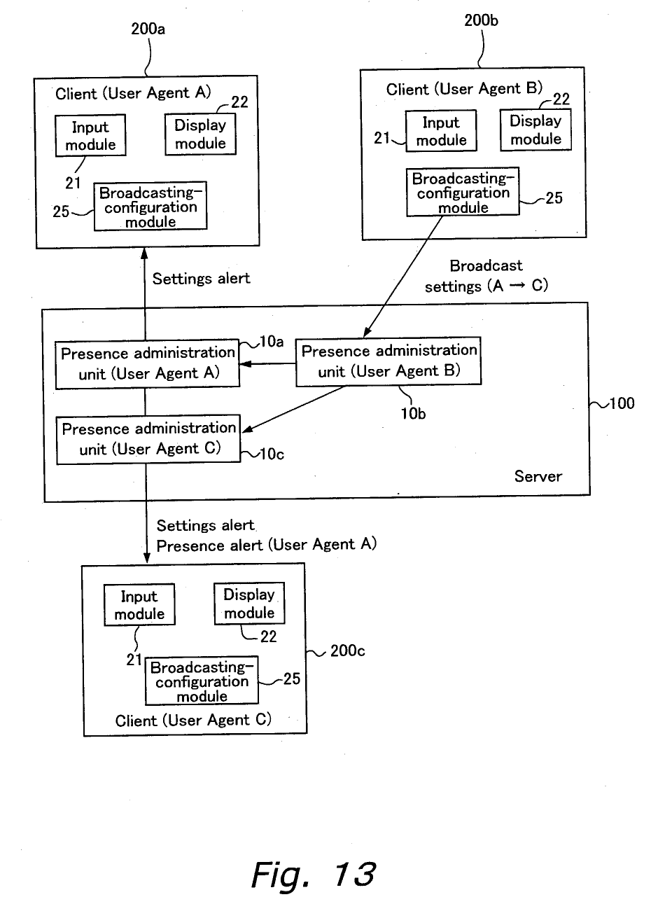

FIG. 13 is an overall configurational view of a presence system having to do with a third embodiment example. In this presence system, any given user agent B may establish a user agent C as a watcher for user agent A. This presence system includes a server 100 and a plurality of clients 200a, 200b, 200c . . . . Clients 200a, 200b, 200c, . . . are operated by user agents A, B, C, . . . . The server 100 has presence administration units 10a, 10b, 10c, . . . that correspond to clients 200a, 200b, 200c, . . . .

The presence administration units 10 principally have the following functions s1 through s5.

(s1) User-agent presence-information administration

(s2) Administration of presence-information broadcasting relationships

(s3) Internal change notification

(s4) Presence notification

(s5) Configuring the broadcasting of presence information among user agents apart from the corresponding user agent

(s6) Controlling the canceling of aforementioned broadcasting settings

The clients 200 principally have the following functions c1 through c4

(c1) Registering on the server 100 presence information on user agents who operate clients

(c2) Registering buddies on the server 100

(c3) Acquiring and displaying presence information on buddies

(c4) Registering on the server 100 presence-information broadcasting relationships among other clients

(c5) Canceling the just-noted broadcasting relationships

(2) Server

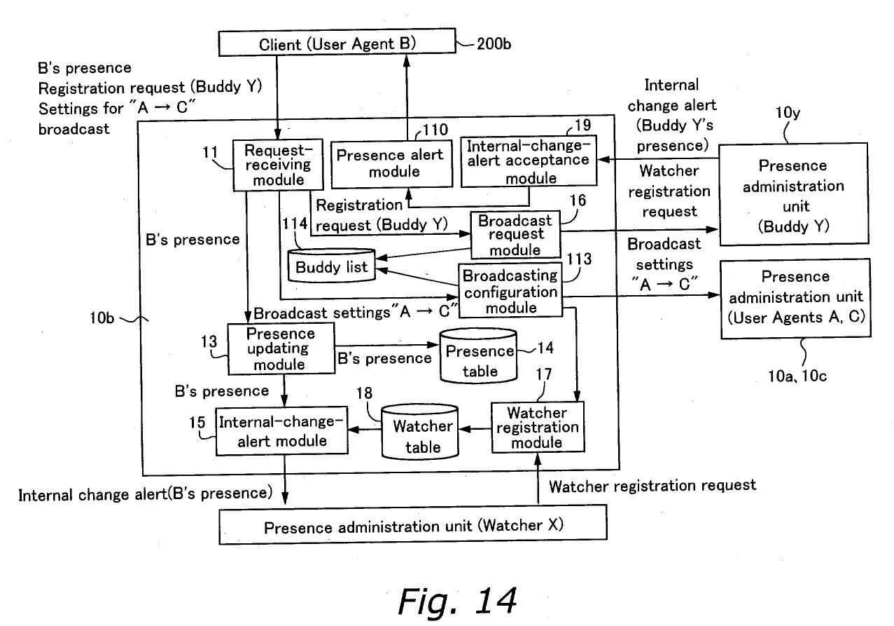

FIGS. 14, 15 and 16 is a block diagram illustrating a functional configuration that the presence administration units 10a, 10b, 10c in the server 100 represented FIG. 13 have. In the figure, configurational elements that function likewise as those in the first embodiment example are shown labeled with identical reference marks. Additionally to the functional configuration of the first embodiment example, presence administration unit 10b has a broadcasting configuration module 113. In the following, an explanation of the functioning of the presence administration units 10a, 10b, 10c will be made, taking as an example an instance in which user agent B establishes user agent C as a watcher for user agent A. It should be understood that presence administration unit 10a has the functions that presence administration units 10b and 10c do, and that the functions of the other presence administration units 10 are the same. The functions of the presence administration units 10 will be described in more detail below, in correlation with Functions s1 through s5 just listed.

(s1, s3, s4) Presence-Information Administration, Internal Change Notification and Presence Notification

Presence information on user agent B transmitted to server 100 from client 200b is received by the request-receiving module 11, and written into the presence table 14 by the presence updating module 13 (FIG. 14 reference; Function s1). The just-noted presence information is moreover sent to presence administration unit 10x for user agent B's Watcher X by the internal-change-notification module 15 (FIG. 14 reference; Function s3). The aforementioned presence information is thereafter sent by the presence notification module 110 for presence administration unit 10x to corresponding client 200x (presence notification, Function s4).

(s2) Administration of Presence-Information Broadcasting Relationships

Buddy Y registration requests from client 200b are received by the request-receiving module 11 and written into a buddy list 114 by the broadcast request module 16 (FIG. 14 reference). User agent Y is thereby stored in the buddy list 114 as a buddy of user agent B. This registration request is furthermore transmitted by the broadcast request module 16 to presence administration unit 10y for Buddy Y (FIG. 14 reference; function s2). User agent B is stored in the watcher table 18 in presence administration unit 10y as a watcher for Buddy Y.

(s5) Broadcasting Settings

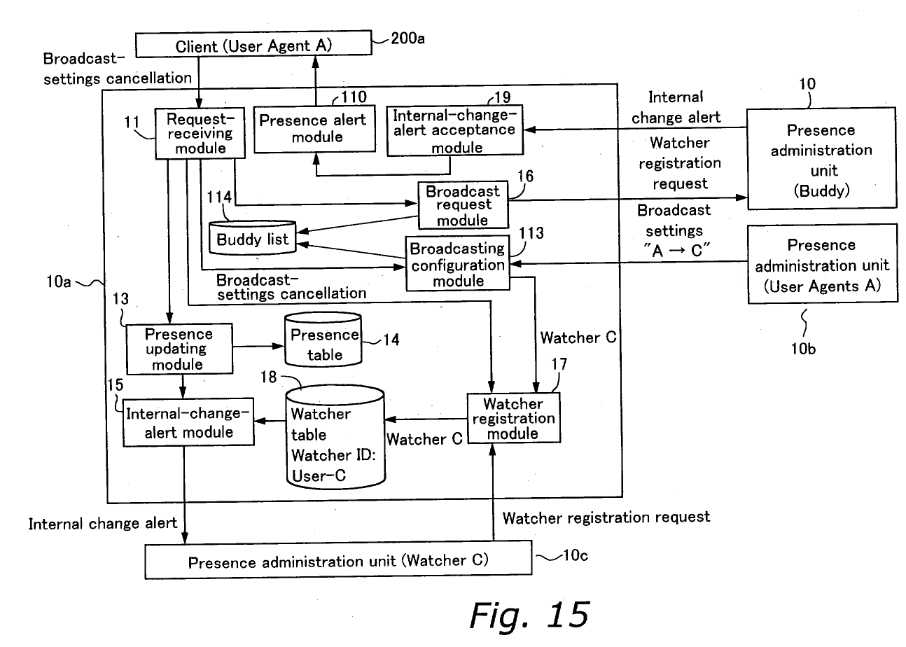

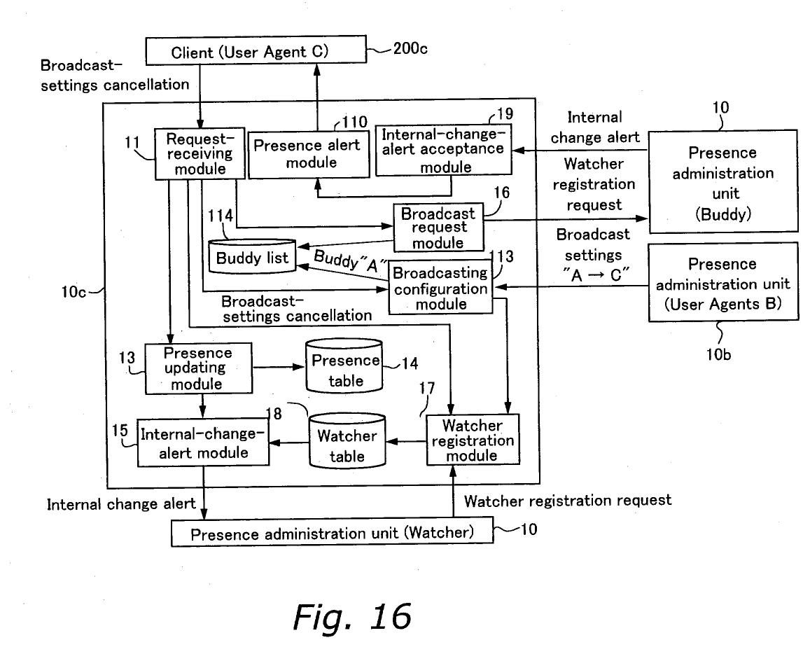

Broadcasting relationships from client 200b are received by the request-receiving module 11 (FIG. 14 reference). A conceivable example is a broadcasting setting that establishes user agent C as user agent A's watcher. This broadcasting setting would be reported by the broadcasting configuration module 113 to presence administration units 10a and 10c for user agents A and C (FIGS. 15 and 16 reference). Specifically, presence administration unit 10a for user agent A, who is established as a presentity, stores user agent C as a watcher (FIG. 15 reference). Likewise, presence administration unit 10c for user agent C, who is established as a watcher, stores user agent A as a buddy (FIG. 16 reference). The broadcasting settings by user agent B thus provide for the latest presence information on user agent A to be broadcast to user agent C.

(s6) Canceling of Broadcasting Settings

Broadcasting settings configured as noted above by a third party may be made to be cancelable only by the configurant. Likewise, it is possible to restrict a presentity's or a watcher's canceling of broadcasting settings configured as noted above by a third party. Restricting the cancellation of broadcasting settings will be explained below. To simplify the explanation, a situation in which user agent B has established user agent C as user agent A's watcher will be taken as an example.

In order to restrict broadcasting configuration, the broadcasting settings from user agent B may include, in addition to the presentity and watcher designations, a broadcasting configurant ID, a presentity flag, and a watcher flag. The presentity flag specifies whether or not clearing of the broadcasting settings by the presentity is possible. The watcher flag designates whether or not cancellation of the broadcasting settings by the watcher is possible.

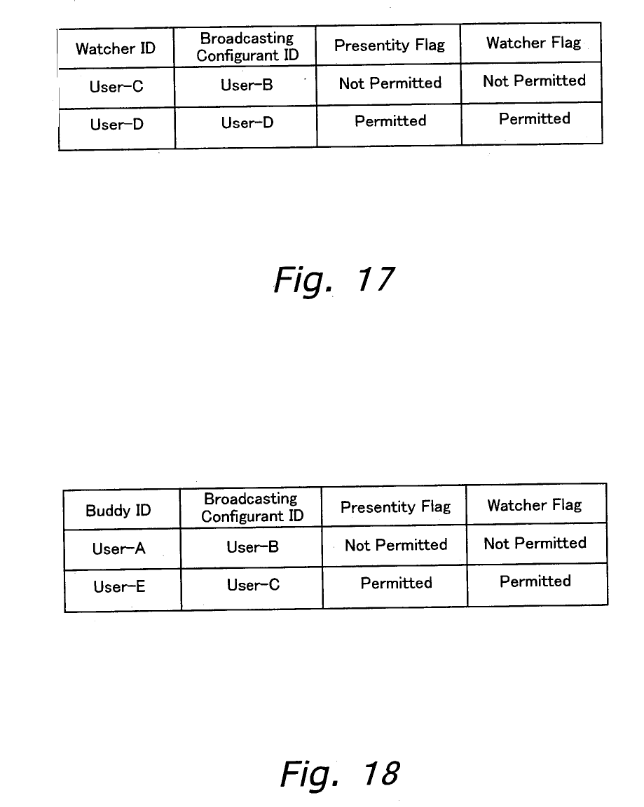

FIGS. 17 and 18 are conceptual explanatory diagrams of a watcher table and a buddy list based on broadcasting settings such as these. FIG. 17 is a conceptual explanatory diagram of a watcher table for user agent A. “Watcher ID,” “Broadcasting Configurant ID,” “Presentity Flag,” and “Watcher Flag” are stored in a single record in the watcher table. The watcher ID is an identifier that specifies a user agent A's watcher. The broadcasting configurant ID represents an identifier for the user-agent who has established the watcher, and ordinarily coincides with the watcher ID. An example in which clearing of the broadcasting settings by the presentity and the watcher is prohibited is shown in this diagram. Conversely, the broadcasting settings by the watcher him/herself then are clearable.

FIG. 18 sets forth a conceptual explanatory diagram of a user agent C buddy list in which watchers are established. “Buddy ID,” “Broadcasting Configurant ID,” “Presentity Flag,” and “Watcher Flag” are stored in a single record in the buddy list. The buddy ID is an identifier that specifies a user agent C's buddy. An example in which clearing of the broadcasting settings by the presentity and the watcher is prohibited is shown in this diagram. Moreover, in the situation herein, in which user agent C him/herself has designated the buddies, either the buddies who are the presentities, or user agent C who is a watcher, can cancel the broadcasting settings.

Cancellation of the broadcasting settings represented in FIGS. 17 and 18 is controlled by the broadcasting configuration module 113 in the following way, for example. An instruction from user agent A to cancel a broadcasting setting is ignored if the presentity flag is “Not Permitted.” If the presentity flag is “Permitted,” the applicable record is deleted from user agent A's watcher table 18. The clearing of the broadcasting setting is then reported to presence administration unit 10c, and the applicable record is deleted from user agent C's buddy list 114.

In the same way, an instruction from user agent C, who is a watcher, to cancel a broadcasting setting is ignored if the watcher flag is “Not Permitted.” If the watcher flag is “Permitted,” the applicable record is deleted from user agent C's buddy list 114. The cancellation of the broadcasting setting is then reported to presence administration unit 10a, and the applicable record is deleted from user agent A's watcher table 18.

(3) Clients

Functioning of the clients 200 in the present invention will be explained with reference once more to FIG. 13. In the figure, elements labeled with reference marks that are the same as those in the foregoing first embodiment example function likewise as described earlier. The clients 200 have, in addition to the configurational elements in the first embodiment example, broadcasting-configuration modules 25. The broadcasting-configuration modules 25 accept settings for broadcasting among the other clients.

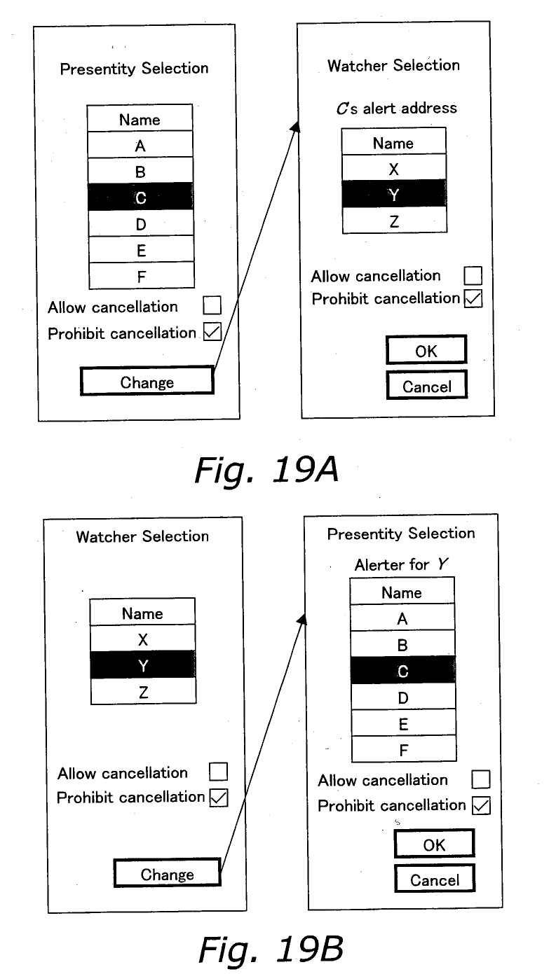

FIG. 19 is examples of broadcasting-settings menus that the broadcasting-configuration modules 25 display. In the figure, (a) sets forth example menus for a situation in which a watcher is being determined after a presentity has been determined. In addition to presentity and watcher determinations, these menus accept a setting as to whether or not to permit broadcasting-settings cancellation by the presentity and/or watcher. In the same figure, (b) is example menus for a situation in which a presentity is being determined after a watcher has been determined. With these menus too, a setting as to whether or not to permit broadcasting-settings cancellation by the watcher and/or presentity can be accepted. The presentities, watchers, presentity flags, and watcher flags established on these menus are transmitted from the clients 200 to the server 100 and stored.

(4) Process

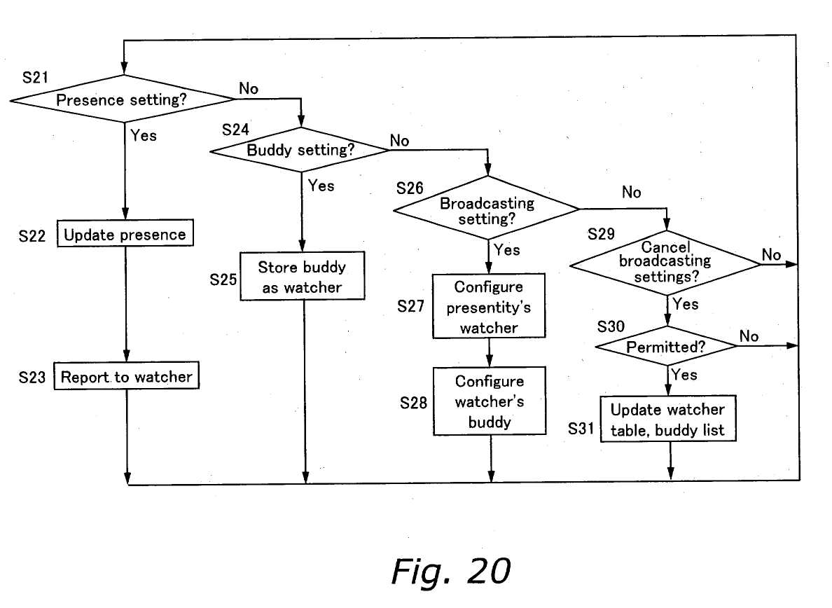

FIG. 20 is a flowchart representing an example of the flow of a process in the present-embodiment presence system overall.

Steps S21, S22, S23: When the server 100 receives a presence-information setting from any of the clients 200, the presence information for that client is updated (S22), and a presence alert is transmitted to that client's watcher (S23).

Steps S24, S25: When the server 100 receives a buddy-registration request from any of the clients 200 (S24), the designated buddy is added to the buddy list 114 for that client, and the requesting client is registered in the buddy's watcher table 18 (S25).

Steps S26, S27, S28: If the server 100 has received a broadcasting-relationship setting from any of the clients 200 (S26), then the presentity and watcher each are stored (S27, S28).

Steps S29, S30, S31: When the server 100 receives a broadcasting-setting cancellation from any of the clients 200 (S29), it judges whether or not broadcasting-setting cancellation is permitted (S30). If cancellation is permitted, then the server 100 updates the relevant presentity's watcher table 18, and the relevant watcher's buddy list 114 (S31).

Thus rendering the present embodiment enables the broadcasting of presence information in accordance with broadcasting settings by third parties. Incorporating presentity flags and watcher flags into the broadcasting settings makes for restricting third-party cancellation of presentities' and watchers' settings.

### Other Embodiment Examples

(A) The foregoing first through third embodiment examples may be combined according to needs.

(B) The present invention includes recording media on which are recorded programs that execute the foregoing methods under the present invention. Recording media herein may be, to name examples, flexible disks, hard disks, semiconductor memory, CD-ROMs, DVDs, magneto-optical disks (MOs), and other computer-read/writeable recording media.

### Embodiment Example

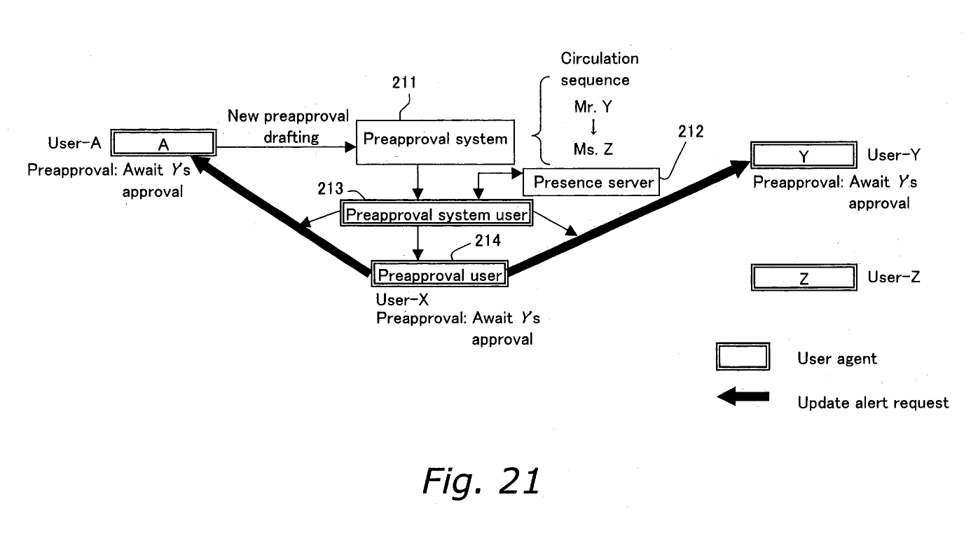

FIG. 21 is an explanatory diagram for an embodiment example in which the presence systems of the first and third embodiment examples have been adapted to a preapproval system. The preapproval system is a system for drafting a preapproval memo and sending it around on a network. In a situation in which user agent A at identifier “User-A” has prepared a preapproval memo on a preapproval system 211, the preapproval memo is given to identifier “User-X” on a presence system. The preapproval memo (User-X) is circulated on the preapproval system 211 to user agent Y (ID: User-Y) and user agent Z (ID: User-Z), following a set circulation sequence. A preapproval-system user 213 creates presence information as to preapproval memo (User-X) on the preapproval system 211, and registers as watchers thereof user agents A, Y and Z in a presence sever 212.

The preapproval-system user 213 then makes settings for broadcasting presence information from the preapproval memo, i.e., user agent X, to user agent A. In the same way, the preapproval-system user 213 configures relationships for broadcasting from user agent X to user agent Y, and from user agent X to user agent Z. These broadcasting relationships may be created on a single occasion, or succeeding broadcasting relationships may be determined each time a preapproval memo is circulated. Likewise, broadcasting settings that prove unnecessary in an instance in which a preapproval is circulated are preferably cancelled. User agent A, having drafted a preapproval memo, can at any time apprehend at whose place the preapproval memo presently is, and its status as to who has approved it.

Utilizing the present invention enables restricting presentities against altering presence information. Likewise, utilizing the present invention enables third parties to determine relationships for broadcasting presence information. Furthermore, utilizing the present invention enables restricting presentities and watchers against canceling established presence-information broadcasting relationships.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A presence administration method for utilization in a presence administration device that administrates presence information on a client group including a first client, the presence administration method including:
a presence-storage step of storing client-by-client presence information on the client group;
a broadcast-destination storage step of storing, client-by-client, identifiers for broadcasting destinations for the presence information on the client group;
an information-receipt step of receiving, from the first client, notification (referred to as “first configuration alert” hereinafter) of fresh presence information on the first client;
an update control step of judging whether to update the presence information on the first client when the first configuration alert has been received, and controlling updating of the presence information according to the judgment results; and
a broadcast step of broadcasting the updated presence information to the first client's presence-information broadcasting destination if the presence information has been updated in said update control step.

2. The presence administration method set forth in claim 1, the presence information including regular presence information, being configurable by presence-information possessors, and restricted presence information, being nonconfigurable by presence-information possessors; wherein said update control step includes:
a substep of judging whether the fresh presence information received in the first configuration alert is regular presence information or restricted presence information;
a substep, if the fresh presence information is regular presence information, of updating the regular presence information on the first client; and
a substep, if the fresh presence information is restricted presence information, of not updating the restricted presence information on the first client.

3. The presence administration method set forth in claim 1, wherein:
said information-receipt step further receives, from a second client included in the client group, notification (second configuration alert) of fresh presence information on the first client; and
said update control step updates, based on the second configuration alert, the presence information on the first client.

4. The presence administration method set forth in claim 3, the presence information including restricted presence information, being nonconfigurable by presence-information possessors, and identifiers for enabled configurants permitted to configure the restricted presence information; wherein said update control step includes:
a substep of judging whether or not the fresh presence information received in the second configuration alert is restricted presence information;
a substep, if the fresh presence information is restricted presence information, of judging whether or not the second client is an enabled configurant; and
a substep, if the second client is an enabled configurant, of updating based on the first configuration alert the restricted presence information on the first client.

5. The presence administration method set forth in claim 3, the presence information including a plurality of restricted presence information candidates, being nonconfigurable by presence-information possessors; further including:
a selection step of accepting from the first client among the restricted presence information candidates selection of which candidate is to be made current restricted presence information; wherein
said update control step judges whether or not the restricted presence information received through the second configuration alert is the current restricted presence information, and based on the judgment results updates the current restricted presence information for the first client.

6. The presence administration method set forth in claim 5, further including a candidate-selection step of accepting selection of the restricted presence-information candidate.

7. A presence administration device for administrating presence information on a client group including a first client, the presence administration device comprising:
presence-storage means for storing client-by-client presence information on the client group;
broadcast-destination storage means for storing, client-by-client, identifiers for broadcasting destinations for the presence information on the client group;
information-receipt means for receiving, from the first client, notification (referred to as “first configuration alert” hereinafter) of fresh presence information on the first client;
update control means for judging whether to update the presence information on the first client when a first configuration alert has been received, and controlling updating of the presence information according to the judgment results; and
broadcast means for broadcasting the updated presence information to the first client's presence-information broadcasting destination if the presence information has been updated in said update control step.

8. A presence administration computer product utilized in a computer that administrates presence information on a client group including a first client, the presence administration computer product for causing the computer to function as:
presence-storage means for storing client-by-client presence information on the client group;
broadcast-destination storage means for storing, client-by-client, identifiers for broadcasting destinations for the presence information on the client group;
information-receipt means for receiving, from the first client, notification (referred to as “first configuration alert” hereinafter) of fresh presence information on the first client;
update control means for judging whether to update the presence information on the first client when the first configuration alert has been received, and controlling updating of the presence information according to the judgment results; and
broadcast means for broadcasting the updated presence information to the first client's presence-information broadcasting destination if the presence information has been updated in said update control step.

9. A computer-readable recording medium on which is recorded a presence administration program utilized in a presence administration device for administrating presence information on a client group including a first client, the computer-readable recording medium on which is recorded the presence administration program for executing:
a presence-storage step of storing client-by-client presence information on the client group;
a broadcast-destination storage step of storing, client-by-client, identifiers for broadcasting destinations for the presence information on the client group;
an information-receipt step of receiving, from the first client, notification (referred to as “first configuration alert” hereinafter) of fresh presence information on the first client;
an update control step of judging whether to update the presence information on the first client when the first configuration alert has been received, and controlling updating of the presence information according to the judgment results; and
a broadcast step of broadcasting the updated presence information to the first client's presence-information broadcasting destination if the presence information has been updated in said update control step.

10. A presence configuration method including:
a connection step of connecting to a presence administration device as a first client, wherein the presence administration device administrates presence information on a client group including the first client group; and
a configuration control step of restricting configuration of the presence information on the first client, and transmitting to the presence administration device presence information for which configurational settings have been accepted.

11. A presence configuration method including:
a connection step of connecting to a presence administration device as a second client, wherein the presence administration device administrates presence information on a client group including a first client and the second client; and
a transmission step of transmitting to the presence administration device a presence-information report containing fresh presence information on the first client.

12. A presence administration method for utilization in a presence administration device that administrates presence information on a client group including a first client, a second client and a third client, the presence administration method including:
a presence-storage step of storing client-by-client presence information on the client group;
a broadcast-configuration step of accepting from the third client a broadcasting setting designating the second client to be a broadcast destination for the presence information on the first client;
a broadcast-configuration storage step of storing the broadcasting setting;
an information reception step of receiving notification of fresh presence information on the first client;
a broadcast step of broadcasting to the second client the presence information on the first client, based on the broadcasting setting.

13. The presence administration method set forth in claim 12, further including:
a cancellation-reception step of receiving an instruction for cancellation of the broadcasting setting; and
a first cancellation control step of judging whether the instruction for cancellation of the broadcasting setting has been transmitted from the second client, having been established as a broadcast destination for the presence information, and restricting cancellation of the broadcasting setting based on the judgment results.

14. The presence administration method set forth in claim 13, wherein:
said broadcast-configuration step further accepts setting of a broadcaster flag indicating whether the second client, established as a broadcast destination for the presence information, can cancel the broadcasting setting;
said broadcast-configuration storage step further stores the broadcaster flag; and
said first cancellation control step restricts cancellation of the broadcasting setting, based on the broadcaster flag.

15. The presence administration method set forth in claim 12, further including:
a cancellation-reception step of receiving an instruction for cancellation of the broadcasting setting configured by the third client; and
a second cancellation control step of judging whether the instruction for cancellation of the broadcasting setting has been transmitted from the first client, being a presence-information provider, and restricting cancellation of the broadcasting setting based on the judgment results.

16. The presence administration method set forth in claim 15, wherein:
said broadcast-configuration step further accepts setting of a provider flag indicating whether the first client, designated as a presence-information provider, can cancel the broadcasting setting;
said broadcast-configuration storage step further stores the provider flag; and
said second cancellation control step restricts cancellation of the broadcasting setting, based on the provider flag.

17. A presence administration device for administrating presence information on a client group including a first client, a second client and a third client, the presence administration device comprising:
presence-storage means for storing client-by-client presence information on the client group;
broadcast-configuration means for accepting from the third client a broadcasting setting designating the second client to be a broadcast destination for the presence information on the first client;
broadcast-configuration storage means for storing the broadcasting setting;
information reception means for receiving notification of fresh presence information on the first client;
broadcast means for broadcasting to the second client the presence information on the first client, based on the broadcasting setting.

18. A presence administration computer product for running on a computer that administrates presence information on a client group including a first client, a second client and a third client, the presence administration computer product for causing the computer to function as:
presence-storage means for storing client-by-client presence information on the client group;
broadcast-configuration means for accepting from the third client a broadcasting setting designating the second client to be a broadcast destination for the presence information on the first client;
broadcast-configuration storage means for storing the broadcasting setting;
information reception means for receiving notification of fresh presence information on the first client;
broadcast means for broadcasting to the second client the presence information on the first client, based on the broadcasting setting.

19. A computer-readable recording medium on which is recorded a presence administration program utilized for administrating presence information on a client group including a first client, a second client and a third client, the computer-readable recording medium on which is recorded the presence administration program for executing:
a presence-storage step of storing client-by-client presence information on the client group;
a broadcast-configuration step of accepting from the third client a broadcasting setting designating the second client to be a broadcast destination for the presence information on the first client;
a broadcast-configuration storage step of storing the broadcasting setting;
an information reception step of receiving notification of fresh presence information on the first client;
a broadcast step of broadcasting to the second client the presence information on the first client, based on the broadcasting setting.

20. A presence broadcast-configuration method including:
a connection step of connecting to a presence administration device as a third client, wherein the presence administration device administrates presence information on, and broadcasting it to, a client group including a first client, a second client, and the third client; and
a transmission step of transmitting to the presence administration device a broadcasting setting designating the second client to be a broadcast destination for the presence information on the first client.
